(19) United States
(12) Patent Application Publication
(10) Pub. No.: US 2015/0229774 A1
(43) Pub. Date: Aug. 13, 2015

(54) IP Emergency Call Station with Mass Notification Voice Alerting

(71) Applicant: VALCOM, INC., Roanoke, VA (US)

(72) Inventors: John W. Mason, Roanoke, VA (US); Gary Rice, Roanoke, VA (US); Donald E. Dillon, Wirtz, VA (US)

(73) Assignee: VALCOM, INC., Roanoke, VA (US)

(21) Appl. No.: 14/492,939

(22) Filed: Sep. 22, 2014

Related U.S. Application Data
(60) Provisional application No. 61/880,626, filed on Sep. 20, 2013.

(51) Int. Cl. H04M 11/04

(52) U.S. Cl. CPC H04M 11/04

(57) ABSTRACT

An emergency call station provides emergency communication services for a user to contact an emergency responder. The call station includes an integrated IP video camera, an integrated security console, and at least one processor configured to provide network supervision status monitoring and notification, status message escalations, logging voice and video, text-to-speech conversion, multilevel forwarding, remote management of endpoints, pre-recorded messages, InformaCast® Compatibility; and mass emergency notification to multiple responders.

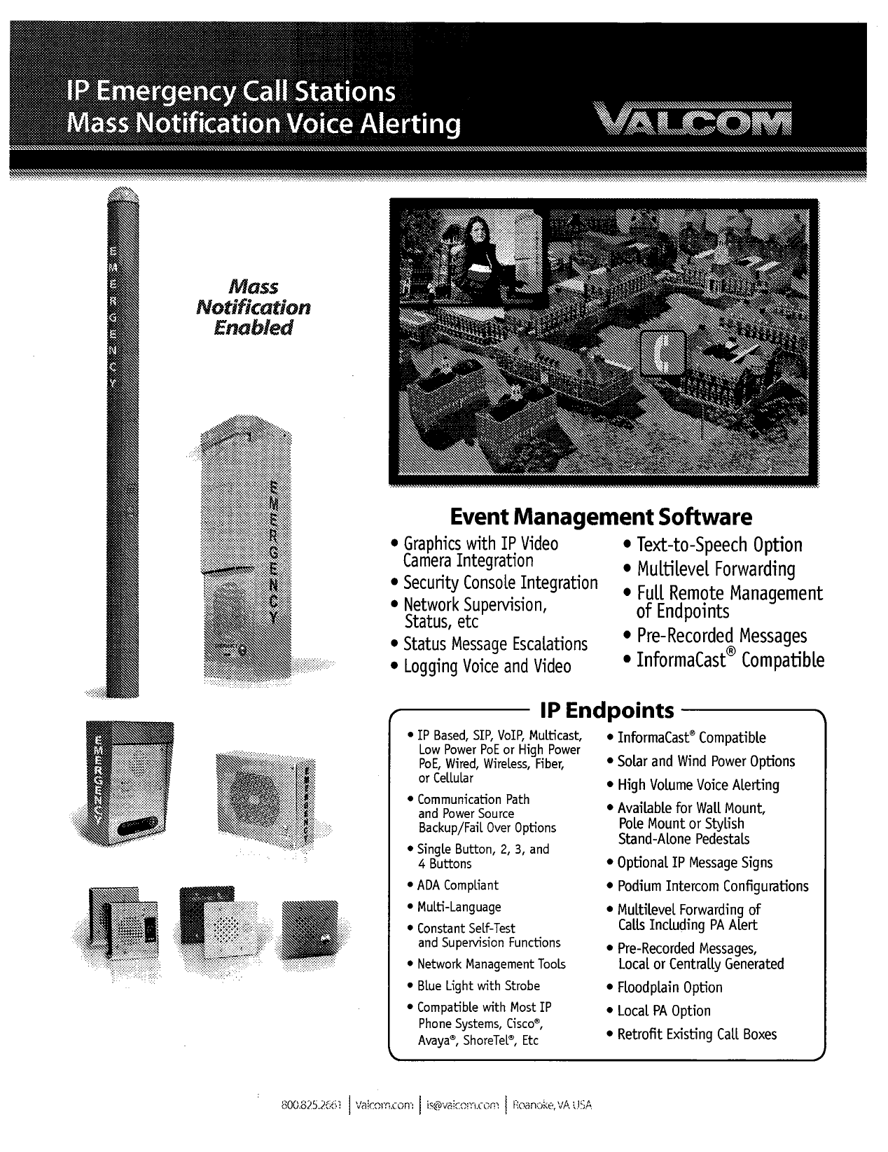

The present invention is directed to an IP phone equipped emergency call station with mass notification voice alerting.

The call station includes event management software having the following features:

Graphics with IP Video; Camera Integration; Security Console Integration; Network Supervision Status; Status Message Escalations; Logging Voice and Video; Text-to-Speech Option; Multilevel Forwarding; Full Remote Management of Endpoints; Pre-Recorded Messages; InformaCast® Compatibility; mass notification enabled.

IP endpoints include the following features:

IP Based, SIP, VoIP, Multicast, Low Power PoE or High Power PoE, Wired, Wireless, Fiber, or Cellular; Communication Path and Power Source Backup/Fail Over Options; Single Button, 2, 3, and 4 Button call operation; ADA Compliant; Multi-Language; Constant Self-Test and Supervision Functions; Network Management Tools; Blue Light with Strobe; Compatible with Most IP Phone Systems, including Cisco®, Avaya®, and ShoreTel®; InformaCast® Compatible; Solar and Wind Power Options; High Volume Voice Alerting; Available for Wall Mount, Pole Mount or Stylish Stand-Alone Pedestals; Optional IP Message Signs; Podium Intercom Configurations; Multilevel Forwarding of Calls Including PA Alert; Pre-Recorded Messages, Local or Centrally Generated; Floodplain Option; Local PA Option; Retrofit Existing Call Boxes.

### DESCRIPTION OF DRAWINGS

The attached brochure illustrates the various features of the IP emergency call station and various embodiments thereof.

1. An emergency call station providing emergency communication services for a user to contact an emergency responder, comprising:
an integrated IP video camera;
an integrated security console;
at least one processor configured to provide
network supervision status monitoring and notification;
status message escalations;
logging voice and video;
text-to-speech conversion;
multilevel forwarding;
remote management of endpoints;
pre-recorded messages;
InformaCast® Compatibility; and
mass emergency notification to multiple responders.
